(19) United States
(12) Patent Application Publication
(10) Pub. No.: US 2012/0138106 A1
(43) Pub. Date: Jun. 7, 2012

(54) DISHWASHER WITH SINGLE VALVE TO FILL MULTIPLE COMPARTMENTS

(75) Inventors: JORDAN R. FOUNTAIN, ST. JOSEPH, MI (US); RODNEY M. WELCH, EAU CLAIRE, MI (US)

(73) Assignee: WHIRLPOOL CORPORATION, BENTON HARBOR, MI (US)

(21) Appl. No.: 12/959,673

(22) Filed: Dec. 3, 2010

(51) Int. Cl. B08B 3/00

(52) U.S. Cl. 134/111

(57) ABSTRACT

A dishwasher with multiple, physically separate treating chambers includes a pump unit, a system for fluidly coupling the separate treating chambers to the pump unit, and a water supply system.

### BACKGROUND OF THE INVENTION

Dishwashers may include multiple compartments in the form of multiple drawers or pull-out compartments slidably mounted in a chassis. Each compartment may include a tub at least partially defining a treating chamber. Typically, a dish rack is provided in each treating chamber to support utensils during a treating cycle of operation. A system to provide and recirculate liquid may be included so that liquid may be used to remove soils from the utensils. In most multi-compartment dishwashers, a cycle of operation may be performed in one or both of the treating chambers to wash utensils contained therein.

### SUMMARY OF THE INVENTION

The invention relates to a dishwasher having multiple physically separate treating chambers, a common pump unit, a liquid diverter system for selectively fluidly coupling the separate treating chambers to the pump unit, and a water supply system comprising a supply conduit extending from a liquid source to the pump unit and wherein the water supply system provides liquid to the pump unit, which then selectively supplies the liquid to both the treating chambers, thereby eliminating the need for separate water supplies for the treating chambers.

### BRIEF DESCRIPTION OF THE DRAWINGS

In the drawings:

FIG. 1 is a perspective view of a multi-compartment dishwasher in accordance with the present invention having an upper compartment in a closed position and a lower compartment in an open position.

FIG. 2 is a cross-sectional view through line 2-2 of FIG. 1, with the upper and lower compartments both shown in the closed position.

FIG. 3 is a rear view of the dishwasher of FIG. 1 with the rear wall removed.

FIG. 4 is a cross-sectional view through line 4-4 of FIG. 3.

FIG. 5 is a schematic view of a controller of the dishwasher of FIG. 1.

### DESCRIPTION OF EMBODIMENTS OF THE INVENTION

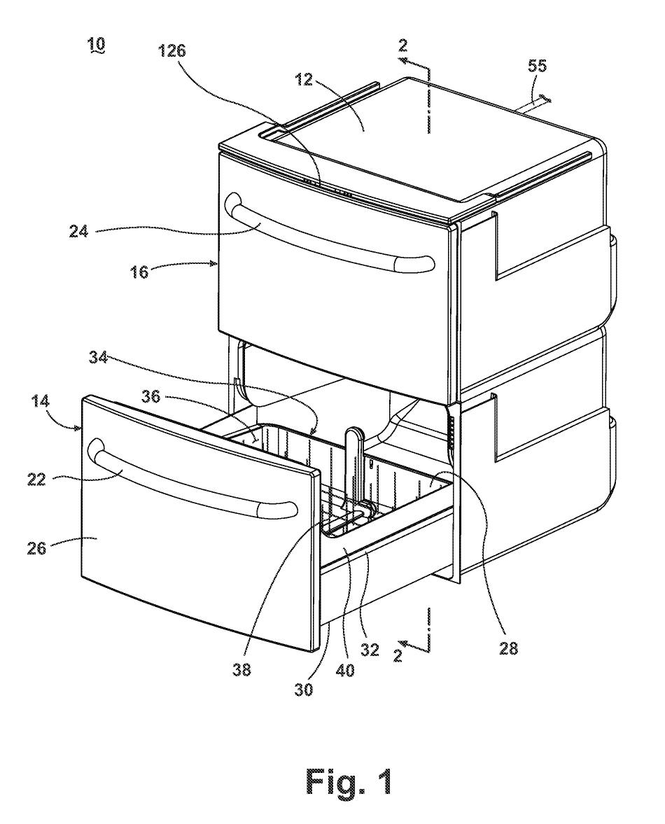

FIG. 1 is a perspective view of a multi-compartment dishwasher 10 according to an embodiment of the invention. Although the actual dishwasher 10 into which the embodiments of the invention may be incorporated may vary, the invention is shown in connection with the dishwasher 10 depicted as a multi-compartment drawer-type dishwasher. The dishwasher 10 includes a chassis 12, which defines an interior. The chassis 12 may be a cabinet or a frame, with or without exterior panels. Built-in dishwashers typically have only a frame without panels, whereas stand alone dishwashers have a frame with decorative panels covering the frame. A lower compartment 14 and an upper compartment 16 are illustrated as being included in the dishwasher 10. These lower and upper compartments 14, 16 are illustrated as being slide-out drawer units of similar size, each having a handle 22, 24, respectively, for facilitating movement of the drawer units between an open and closed position. However, one compartment 14, 16 may have a small or medium capacity so as to be used for washing smaller or more delicate utensils, such as glassware and the like, while the other compartment 14, 16 may be a larger capacity drawer for washing larger or more robust utensils, such as dinnerware, cookware and other large sized objects. Also, the dishwasher 10 could include a combination single pull-out drawer unit and a conventional dishwashing unit, with a hinged door. As used in this description, the term “utensil(s)” is intended to be generic to any item, single or plural, that may be treated in the dishwasher 10, including, without limitation: dishes, plates, pots, bowls, pans, glassware, and silverware.

Lower compartment 14 is shown in the open position in FIG. 1, and includes a front wall 26, a rear wall 28, a bottom wall 30 and opposing side walls 32 that collectively form a first or lower tub 34 that at least partially defines a first or lower treating chamber 36. The lower tub 34 is provided with a utensil rack 38 for supporting various objects, such as utensils and the like, to be exposed to a treating operation. Lower compartment 14 may be slidably mounted to the chassis 12 through a pair of extendible support guides, one of which is indicated at 40. In this manner, the lower compartment 14 may carry the tub 34 between the open and closed positions.

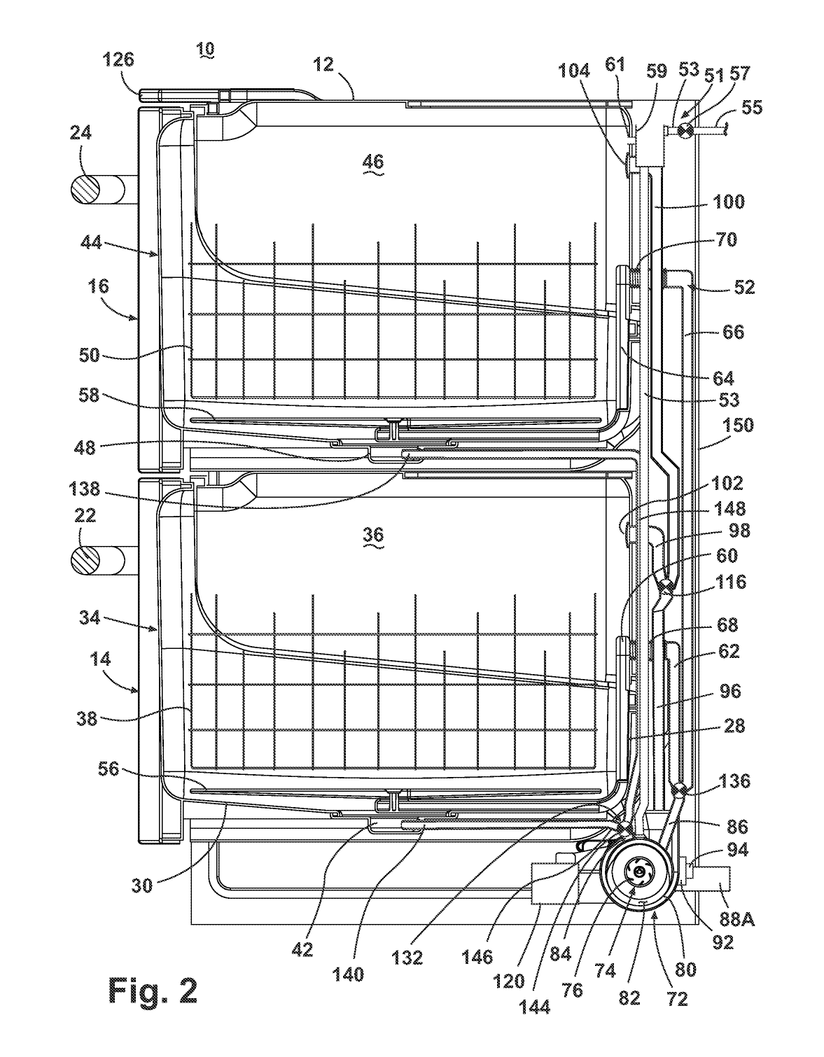

FIG. 2 is a cross-sectional view through line 2-2 of FIG. 1, with both the lower and upper compartments 14, 16 shown in the closed position. Each of the lower and upper compartments 14, 16 have separate liquid inlets and separate liquid outlets. As illustrated in FIG. 2, the bottom wall 30 of the lower tub 34 may be sloped to define a lower tub region or lower sump 42, which provides a first liquid outlet for the lower treating chamber 36. The lower sump 42, which will be discussed more fully below, manages a flow of liquid leaving the lower compartment 14.

Similar to the lower compartment 14, although not shown, the upper compartment 16 similarly includes front, rear, bottom and opposing side walls that collectively form a second or upper tub 44, which at least partially defines a second or upper treating chamber 46 having an upper sump 48, which provides a second liquid outlet for the upper treating chamber 46. The upper treating chamber 46 is physically separate from the lower treating chamber 36. The upper tub 44 may also be provided with a utensil rack 50 for supporting various utensils and the like. Like the lower compartment 14, upper compartment 16 is slidably mounted to the chassis 12 through a pair of extendible support guides (not shown). In this manner, the upper compartment 16 carries the tub 44 between an open and closed position.

The dishwasher 10 may further include a water or liquid supply system 51 and a recirculation system 52, which includes a remote pump and filter unit 72, for selectively supplying, recirculating and draining liquid from the lower and upper treating chambers 36, 46. The recirculation system 52 includes a lower spray arm assembly 56, which provides a first liquid inlet to the lower treating chamber 36. The lower spray arm assembly 56 is illustrated as being positioned in the lower tub 34 beneath the utensil rack 38. The recirculation system 52 also includes an upper spray arm assembly 58, which provides a second liquid inlet to the upper treating chamber 46. The upper spray arm assembly 58 is illustrated as being positioned in the upper tub 44 beneath the utensil rack 50.

Each lower and upper spray arm assembly 56, 58 is configured to rotate in their respective lower and upper treating chamber 36, 46 and generate a spray of liquid in a generally upward direction, over at least a portion of an interior of their respective treating chamber 36, 46, typically directed to treat utensils located in the utensil racks 38, 50. While the spray arm assemblies 56, 58 are illustrated as rotating spray arms, the spray arm assemblies may be of any structure and configuration, such as fixed spray heads, for example. Additional spray arms or nozzles may also be provided. It is also within the scope of the invention for the spray arm assemblies to be provided at different locations within the lower and upper treating chambers 36, 46, such as above the utensil racks 38, 50 or on the rear walls of the lower and upper compartments 14, 16. It is also within the scope of the invention for a combination of spray arm assemblies and/or nozzles to be provided at a multiple locations within the lower and upper treating chambers 36, 46.

The recirculation system 52 also includes a first spray arm conduit 60 provided in the lower tub 34 and is coupled at a first end to the lower spray arm assembly 56. The first spray arm conduit 60 extends along the bottom wall 30 of the lower tub 34 from the lower spray arm assembly 56 and upwardly along the rear wall 28 of the lower compartment 14. A first supply conduit 62 is fluidly coupled to the first spray arm conduit 60 at a second end for supplying liquid to the spray arm assembly 56 via the first spray arm conduit 60. In a similar manner, liquid is supplied to the second spray arm assembly 58 in the upper tub 44 through a second spray arm conduit 64, which is fluidly coupled with a second supply conduit 66.

Because the lower and upper spray arm assemblies 56, 58 are positioned within the lower and upper tubs 34, 44, the lower and upper spray arm assemblies 56, 58 and the first and second spray arm conduits 60, 64 must be able to move with the lower and upper compartments 14, 16 as they move between the open and closed positions. As such, a flexible manifold tube 68, 70 may be fluidly coupled between each of the lower and upper spray arm conduits 60, 64 and their associated lower and upper supply conduits 62, 66 to allow for such movement. Alternatively, it has been contemplated that a docking type connection may be used instead of the flexible manifold tubes. Further, it has been contemplated that telescoping conduits or other types of moveable conduits may be used instead of the flexible manifold tubes described above.

The lower sump 42 may be fluidly coupled with a first sump conduit 140, which is arranged within the dishwasher 10 below the lower tub 34. As illustrated, the first sump conduit 140 extends along the underside of the lower tub 34 from the lower sump 42 to a rear wall 28 of the lower compartment 14. A first outlet conduit 146 is fluidly coupled to the first sump conduit 140 for supplying liquid from the lower sump 42 to the remote pump and filter unit 72. In a similar manner, the upper tub 44 is provided with a second sump conduit 138 that is fluidly coupled with the upper sump 48 and a second outlet conduit 148 that is fluidly coupled with the second pump conduit 138 at a first end and the remote pump and filter unit 72 at a second end. Because the lower and upper sumps 42, 48 are portions of the tubs 34, 44, the sumps 42, 48 must be able to move with the compartments 14, 16 as they move between the open and closed positions. As such, the first and second sump conduits 138, 140 may selectively couple and uncouple with the sumps 42, 48 to allow for such movement. Alternatively, the first and second sump conduits 138, 140 may be configured such that the first and second sump conduits 138, 140 remain coupled with the sumps 42, 48, respectively during movement of the compartments 14, 16.

The liquid diverter system 132 may be included in the recirculation system 52 to selectively control the liquid movement within and between the lower and upper treating chambers 36, 46. The liquid diverter system 132 may include a tub inlet diverter 136 and tub outlet diverter 144 for controlling the movement of liquid within the dishwasher 10. The tub inlet diverter 136 may selectively fluidly couple the remote pump and filter unit 72 to the first and second inlets or spray arm assemblies 56, 58 through the first and second supply conduits 62, 66. The tub outlet diverter 144 may selectively fluidly couple the first and second tub outlets or lower and upper sumps 42, 48, respectively, to the remote pump and filter unit 72. More specifically, the first and second outlet conduits 146, 148 are both in fluid communication with the tub outlet diverter 144 which in turn is fluidly coupled with the remote pump and filter unit 72 to collect liquid supplied to both the lower and upper tubs 34, 44.

The tub inlet diverter 136 and tub outlet diverter 144 may be valve type diverters or other diverter assemblies with one inlet and two outlets or two inlets and one outlet capable of diverting all or some of the liquid therein. In this way, the housing 80 may have an inlet selectively, fluidly coupled to the lower and upper tubs 34, 44 to collect liquid from the lower and upper tubs 34, 44 and having an outlet selectively fluidly coupled to the first and second sprayers to define first and second recirculation flow paths from the sump to the first and second sprayers, respectively.

The dishwasher 10 may also include a liquid supply system 51 that may provide liquid to the remote pump and filter unit 72, where it may then be selectively supplied to either or both of the lower and upper treating chambers 36, 46. This configuration, thereby, eliminates the need for separate liquid supplies for the lower and upper treating chambers 36, 46. The liquid supply system 51 may include a supply conduit 53 extending from a liquid source 55, such as a household water supply to the remote pump and filter unit 72 to direct liquid from the liquid source 55 to the remote pump and filter unit 72. An inlet valve 57 may control flow of the liquid from the liquid source 55 to the supply conduit 53 and the remote pump and filter unit 72. A siphon break or reservoir 59 may be provided at some point in the supply conduit 53 such that the remote pump and filter unit 72 may receive liquid from the liquid source 55 through the supply conduit 53 via the reservoir 59. The reservoir 59 has been illustrated as an open-top cup, separating the supply conduit 53 into a first portion supplying liquid to the reservoir 59 and a second portion fluidly coupling the reservoir 59 to the remote pump and filter unit 72. An overflow conduit 61 may be provided, which fluidly couples the reservoir 59 to one of the lower and upper tubs 34, 44. The reservoir 59 and overflow conduit 61 are designed to keep liquid from siphoning out of the supply conduit 53 and reservoir 59 by providing an air gap.

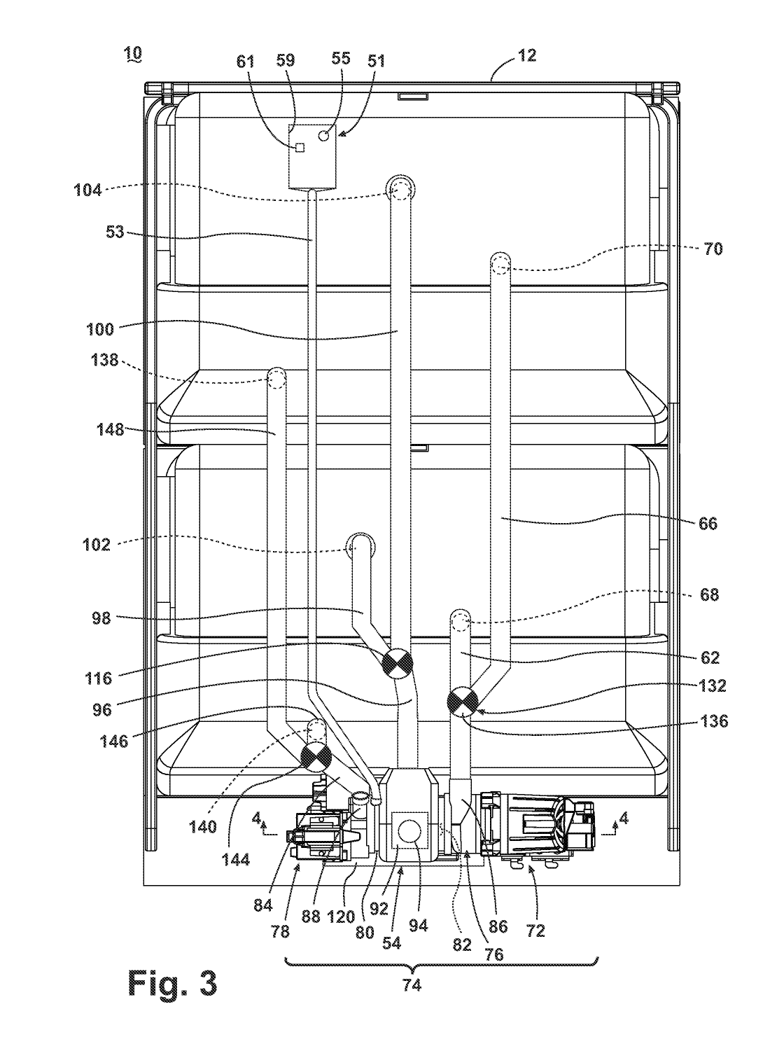

Referring now to FIG. 3, the remote pump and filter unit 72 is illustrated as including a pump assembly 74 that may be fluidly coupled to the recirculation system 52 to aid in the supply, recirculation and draining of liquid to the lower and upper compartments 14, 16. The remote pump and filter unit 72 may include a housing 80, which is physically separate from the upper and lower tubs 44, 34 and the lower and upper compartments 14, 16. The housing 80 may have an interior, defining a remote sump 82. The housing 80 may also include a housing inlet 84 fluidly coupled to both the lower and upper treating chambers 34, 46 such that the housing 80 may define a remote sump 82 for both the lower and upper treating chambers 36, 46.

The pump assembly 74 may include a wash or recirculation pump 76 having a pump outlet conduit 86 that is fluidly coupled with the lower and upper supply conduits 62, 66 through the tub inlet diverter 136 for selectively supplying and/or recirculating liquid to and between the lower and upper treating chambers 36, 46. The pump assembly 74 may also include a drain pump 78 having a drain outlet 88 that is fluidly coupled with the first and second outlet conduits 146, 148 through the tub outlet diverter 144 for selectively draining liquid from the lower and upper treating chambers 36, 46. The tub inlet diverter 136 and tub outlet diverter 144 may be valve type diverters or other diverter assemblies with one inlet and two outlets capable of diverting all or some of the liquid therein.

The remote pump and filter unit 72 may also include an air supply system 54, which is illustrated as including a fan or blower 92 having a blower inlet conduit 94 in fluid communication with the air external to the remote pump and filter unit 72 to intake air from the exterior of the dishwasher 10 and a blower outlet conduit 96 for providing air to the lower and upper treating chambers 36, 46. The air supply system 54 includes a first air conduit 98 fluidly coupled between the blower outlet conduit 96 and the lower tub 34 for supplying air to the lower treating chamber 36 and a second air conduit 100 fluidly coupled between the blower outlet conduit 96 and the upper tub 44 for supplying air to the upper treating chamber 46. An air diverter 116 may be provided for selectively directing air from the blower outlet conduit 96 to one of the first and second air conduits 98, 100.

A portion of the blower outlet conduit 96 may wrap around the housing 80, such that the housing 80 defines an inner wall of the blower outlet conduit 96. In this manner, the housing 80 is a shared wall of the recirculation system 52 and the air supply system 54, which places the recirculation system 52 and the air supply system 54 in conductive contact. One or more flaps or other closing means (not shown) may be used to close off the fluid connection between the blower outlet conduit 96 and the lower and upper tubs 34, 44 during certain portions of a cycle of operation so that liquid does not enter the blower outlet conduit 96. Inlet vents 102, 104 may be provided in each of the lower and upper compartments 14, 16, and may be in fluid communication with air conduits 98, 100 for passing air into the lower and upper treating chambers 36, 46. Additional outlet vents (not shown) may be provided in each of the lower and upper compartments 14, 16 and may be in fluid communication with the surrounding air, either internal or external to allow air in the lower and upper treating chambers 36, 46 to be discharged exteriorly of the tubs 34, 44. In some configurations, one or more additional blowers (not shown) may be provided to force air out through the outlet vents to increase the drying speed.

FIG. 3 also illustrates that a single controller 120 may be provided for both the lower and upper compartments 14, 16, and may be operably coupled to various components of the dishwasher 10 to implement a treating cycle of operation in one or both of the lower and upper compartments 14, 16.

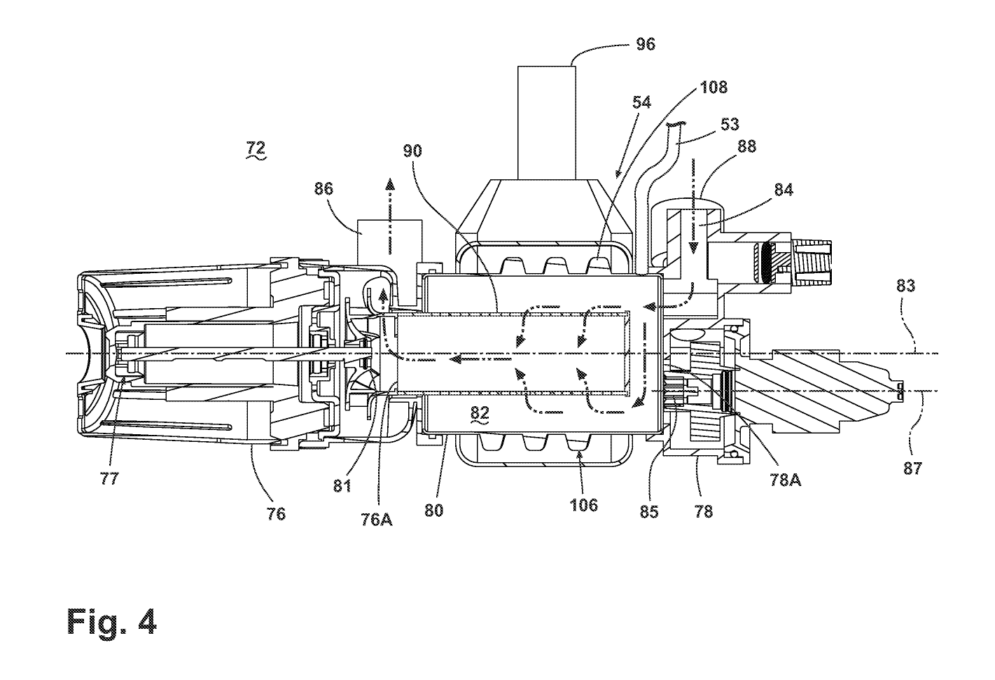

Referring now to FIG. 4, which is a cross-sectional view through line 4-4 of FIG. 3, it may be seen that the recirculation pump 76 may have an inlet 76A fluidly coupled to the housing 80 and an outlet 86. The recirculation pump 76 includes an impeller 81 rotatably mounted within the recirculation pump 76 and expelling liquid from the remote sump 82 through the outlet conduit 86 of the recirculation pump 76. A motor 77 may be operably coupled to the impeller 81 to rotate the impeller 81.

A filter 90 is illustrated as being located within the housing 80 and fluidly separates the housing inlet 84 from the recirculation pump inlet 76A such that soil and foreign objects may be filtered from the liquid. The filter 90 may be a rotating filter as is set forth in detail in U.S. patent application Ser. No. 12/643,394, filed Dec. 21, 2009, and titled “Rotating Drum Filter for a Dishwashing Machine,” which is incorporated herein by reference in its entirety. The rotating filter according to U.S. patent application Ser. No. 12/643,394 may be rotatably mounted in the housing 80 and driven by the impeller 81 of the recirculation pump 76. The filter 90 may be directly mounted to the impeller 81. When the impeller 81 is rotated by the motor 77 the filter 90 is also rotated.

In addition to the filter 90, it is also within the scope of the invention for the dishwasher 10 to include one or more additional filters, coarse strainers, or other fluid particle separators which may use centrifugal filtration, sedimentation, or filtration. For example, at least one additional filter may be located between the lower and upper tub sumps 42, 48 and the remote sump 82 to filter larger soils and debris but allow smaller particles to pass through. An additional filter may also be provided for each lower and upper compartment 14, 16, such as a strainer which is provided at each of the lower and upper tub sumps 42, 48.

The drain pump 78 may also be fluidly coupled to the housing 80. The drain pump 78 may have an inlet 78A fluidly coupled to the housing 80 and an impeller 85 to draw liquid from the housing 80 and to pump the liquid through a drain pump outlet 88 to a household drain conduit 88A (FIG. 2) for draining. It should be noted that the filter 90 does not fluidly separate the remote sump 82 formed by the housing 80 from the drain pump inlet 78A such that the liquid being drained is not filtered. Although separate recirculation and drain pumps have been illustrated, it is possible for the two pumps to be replaced by a single pump, which may be operated to supply liquid to either the household drain or to the recirculation system 52.

The remote pump and filter unit 72 may further include a heating element 106 common to both the recirculation system 52 and the air supply system 54 for heating the liquid and air supplied to the lower and upper treating chambers 36, 46. As illustrated, the heating element 106 is mounted to an exterior of the housing 80. More specifically, the heating element 106 is illustrated as mounted to an exterior of the housing 80 where the blower outlet conduit 96 wraps around the housing 80. In this location, the heating element 106 may heat air and liquid at the same time.

The heating element 106 may be a resistive heating element that is activated by a suitable electrical supply, such as a standard house line voltage to the heating element 106. A standard house line voltage may be between about 110 and 120 volts in the United States, however, it is also within the scope of the invention for the house line voltage to vary, depending on the installation location of the dishwasher 10 and the house line voltage standard for that area. The heating element 106 may also be a variable thermal energy heater, which may be accomplished by altering the duty cycle (ratio of on/off states per unit time) of a fixed wattage heater, a variable wattage heater, or a combination of both. The heating element 106 may have a power rating of less than about 2000 watts. In general, the heating system may supply electricity at 15 amps with a voltage in the range of about 110 to 120 volts to the heating element.

As illustrated, the heating element 106 may be a flow-through heater incorporated with the recirculation pump 76 and having three rings 108 encircling the housing 80. The three rings 108 may be an integral unit or may function independently of each other. As an integral unit, the rings 108 may be part of a heating coil that uses a variable duty cycle to vary the thermal energy output by the heating element 106. As independent rings 108, a desired number of rings 108 may be selectively actuated to obtain the desired thermal energy output. For example, if the heating element 106 is to run at 1/3 thermal energy output, then only one of the three rings 108 may be continuously actuated. A combination of both approaches may be used as well, such as continuously running a subset of all of the rings 108, while operating another one or more of the rings 108 according to a duty cycle.

In addition to a coiled heater or multiple-ring heater, other heating element configurations may be used. For example, it has been contemplated that the heating element 106 may be a thin-film heater mounted on the housing 80. The thin-film heater may comprise one film or multiple films in much the same manner that the rings 108 may be a coil or individual elements.

In FIG. 4, it is also illustrated that the impeller 81 of the recirculation pump 76 has a first rotational axis 83 while an impeller 85 of the drain pump 78 has a second rotational axis 87. It has been contemplated that to keep the remote pump and filter unit 72 low profile the first and second rotational axes 83, 87 may be parallel. Further, in an effort to keep the remote pump and filter unit 72 low profile, the filter element 90 may also have a third rotational axis, which may be parallel to at least one of the first and second rotational axes 83, 87. As illustrated, the third rotational axis is collinear with the first rotational axis 83, and as such has not been separately labeled, and is thus also parallel to the second rotational axis 87. It has been contemplated that the first, second, and third axes of rotation 83, 87, may all be parallel to each other or may all be collinear.

Further, the housing 80 may also have a longitudinal axis. As illustrated, the longitudinal axis of the housing 80 is also collinear with the first rotational axis 83, and as such has not been separately labeled. It may be understood that the recirculation pump 76, drain pump 78, and housing 80 are arranged such that the first and second axes of rotation 83, 87 are generally parallel with the longitudinal axis to form an overall elongated configuration of the remote pump and filter unit 72. Further, it should be noted that a longitudinal axis for the remote pump and filter unit 72 may also be considered to be the same as the first axis of rotation. Although not illustrated as such, it has been contemplated that the longitudinal axis of the housing 80 may be collinear with the first, second, and third axes of rotation to define a longitudinal axis for the remote pump and filter unit 72. The pump and filter unit 72 may be located in a lower-rear portion of the interior of the cabinet 12 (FIG. 2) such that the longitudinal axis of the remote pump and filter unit 72 is generally parallel to the rear wall of the cabinet 12.

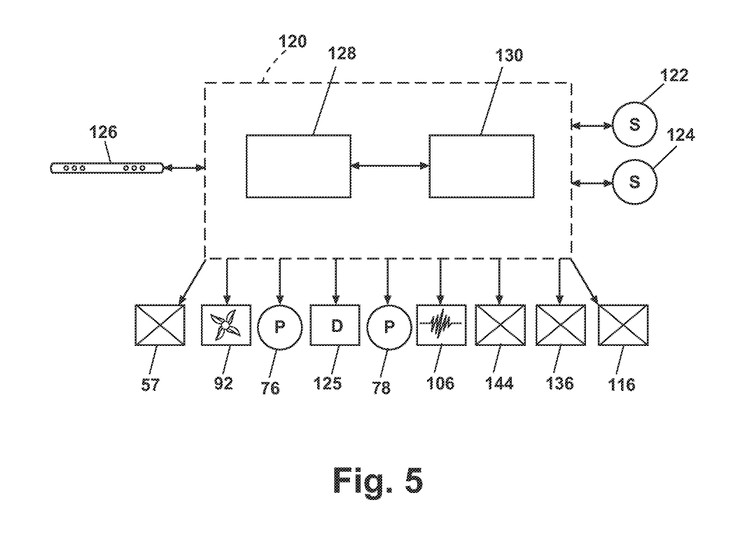

As illustrated in FIG. 5, the controller 120 may be coupled with the recirculation pump 76, tub inlet diverter 136, and tub outlet diverter 144 for circulation of liquid in the lower and upper treating chambers 36, 46 and the drain pump 78 for drainage of liquid from the dishwasher 10. The controller 120 may be coupled with valve 57 for supplying liquid to the remote sump 82. The controller 120 may also be operably coupled with the blower 92 to provide air into the lower and upper treating chambers 36, 46. The controller 120 may also be coupled with the heating element 106 to heat the liquid and/or air depending on the step being performed in the cycle of operation. If the heating element 106 is capable of supplying different wattages, then the controller 120 may also control that aspect of the heating element 106. The controller 120 may also be coupled with one or more temperature sensors 122, which are known in the art, such that the controller 120 may control the duration of the steps of the cycle of operation based upon the temperature detected in the lower and upper treating chambers 36, 46 or in one of various conduits of the dishwasher 10. The controller 120 may also receive inputs from one or more other additional sensors 124, examples of which are known in the art. Non-limiting examples of additional sensors 124 that may be communicably coupled with the controller include a moisture sensor, a door sensor, a detergent and rinse aid presence/type sensor(s). The controller 120 may also be coupled to dispensers 125 provided in each of the lower and upper compartments 14, 16, which may dispense a detergent during a wash step of a cycle of operation or a rinse aid during a rinse step of a cycle of operation, for example. Alternatively, a single dispenser may be shared by both compartments 14, 16.

The dishwasher 10 may be preprogrammed with a number of different treating cycles from which a user may select one treating cycle to treat a load of utensils. Examples of treating cycles include normal, light/china, heavy/pots and pans, and rinse only. A control panel or user interface 126 for use in selecting a treating cycle may be provided on the dishwasher 10 and coupled to the controller 120. The user interface 126 may be provided above the upper compartment 16 and may include operational controls such as dials, lights, switches, and displays enabling a user to input commands to the controller 120 and receive information about the selected treating cycle. Alternately, the treating cycle may be automatically selected by the controller 120 based on soil levels sensed by the dishwasher 10 to optimize the performance of the dishwasher 10 for a particular load of utensils.

The controller 120 may also be provided with a memory 128 and a central processing unit (CPU) 130. The memory 128 may be used for storing control software that may be executed by the CPU 130 in completing a cycle of operation using one or both lower and upper compartments 14, 16 of the dishwasher 10 and any additional software. For example, the memory 128 may store one or more pre-programmed cycles of operation that may be selected by a user and completed by one of the lower and upper compartments 14, 16. A cycle of operation for the lower and upper compartments 14, 16 may include one or more of the following steps: a wash step, a rinse step, and a drying step. The wash step may further include a pre-wash step and a main wash step. The rinse step may also include multiple steps such as one or more additional rinsing steps performed in addition to a first rinsing. The amounts of liquid and/or rinse aid used during each of the multiple rinse steps may be varied. The drying step may have a non-heated drying step (so called “air only”), a heated drying step or a combination thereof. These multiple steps may also be performed by the lower and upper compartments 14, 16 in any desired combination.

As illustrated herein, the controller 120 may be part of the remote pump and filter unit 72 to provide a compact and modular assembly for installation within the dishwasher 10, which also includes the pump assembly 74, filter 90, and heating element 106. However, one or more components shown as integrated with each other in the remote pump and filter unit 72 may also be provided separately. For example, while the heating element 106 is shown as integrated with other components in the remote pump and filter unit 72, each of the components may also be provided within its own independent heating system.

The above-described dishwasher 10 may be used to implement a method for operating a dishwasher having multiple, physically separate lower and upper treating chambers 36, 46. In operation, the valve 57 may be controlled, by the controller 120, to open and close so as to permit liquid to flow through the first portion of the supply conduit 53 to the reservoir 59 where it may then travel through the second portion of the supply conduit 53 and into the housing 80. In this manner, the liquid supply system 51 provides liquid to the remote sump 82, which may then selectively supply the liquid to both the lower and upper treating chambers 36, 46 using the recirculation system 52, thereby, eliminating the need for separate liquid supplies for the lower and upper treating chambers 36, 46.

The dishwasher 10 may selectively supply liquid from the remote sump 82 through the various conduits and tub inlet diverter 136 to only one of the lower and upper compartments 14, 16 or to both of the lower and upper compartments 14, 16 simultaneously. For example, liquid may be supplied to one of the lower and upper treating chambers 36, 46 by selectively diverting the liquid supplied to the outlet conduit 86 using the tub inlet diverter 136. In this manner, the liquid diverter system 132 may selectively establish a recirculation path between the recirculation pump 76 and one of the lower and upper treating chambers 36, 46. In such an instance, the tub inlet diverter 136 may selectively fluidly couple the outlet conduit 86 of the recirculation pump 76 to one of the first and second supply conduits 62, 66, which supply liquid to one of the lower and upper spray arm assemblies 56, 58, respectively. More specifically, the controller 120 may operate the inlet diverter 136 such that liquid may be selectively circulated from the recirculation pump 76 through the tub inlet diverter 136 to one of the supply conduits 62, 66 and the corresponding spray arm assembly 56, 58. Liquid supplied to the one of the lower and upper treating chambers 36, 46 may then exit through the corresponding sump 42, 48 and travel through the outlet diverter 144 back to the recirculation pump 76 where it may be recirculated again. When the operation is done using the liquid, the drain pump 78 may be used to drain the liquid from the remote sump 82, through a drain conduit 88, and out of the dishwasher 10.

Alternatively, the liquid diverter system 132 may fluidly couple both the lower and upper treating chambers 36, 46 to the recirculation pump 76 simultaneously. In such an instance, the tub inlet diverter 136 and the outlet diverter 146 may be operated by the controller 120 such that they may both fluidly couple the recirculation pump 76 to both the lower and upper treating chambers 36, 46. Alternatively, the liquid may be supplied to the different lower and upper treating chambers 36, 46 in a staggered fashion. For example, liquid may first be recirculated between the upper compartment 16 and pump assembly 74 for a period of time and then the tub inlet diverter 136 and outlet diverter 144 may be operated by the controller such that the liquid is then only recirculated between the lower compartment 14 and pump assembly 74 for a period of time.

During the operation of the dishwasher 10, the reservoir 59 may act as a siphon break or air gap device and may prevent liquid from the remote sump 82 from undesirably flowing to the liquid supply 55. That is, if a negative pressure is produced in the water source 55, contaminants will not be drawn into the water source 55 and instead air will be drawn from the overflow conduit 61 into the water source 55. This type of siphon break device is commonly known as an air-gap siphon break, but it is within the scope of the invention for any type of siphon break device to be coupled to the liquid supply system 51. Further, it is also within the scope of the invention for the overflow conduit 61 to be separate from the reservoir 59 or for the reservoir 59 to be employed without the overflow conduit 61.

In addition, any liquids siphoned from the remote sump 82 through the second portion of the supply conduit 53 into the reservoir 59 will flow through the overflow conduit 61 to the upper treating chamber 46. Thus, the siphoned liquids will flow through the overflow conduit 61 rather than through the supply conduit 53 to the liquid source 55. It has also been contemplated that the overflow conduit 61 may alternatively lead to a drain or other area appropriate for such siphoned liquids.

It should be noted that the filter 90 is a rotatable filter and because the liquid in the housing 80 may rotate, sufficient pressure may be generated in the housing 80 to effect the formation of a column of supply water in the supply conduit 53. It has been contemplated that the rotational speed of the filter 90, the configuration of the supply conduit 53, and the location of the reservoir 59 may be selected so that a positive pressure is maintained in the supply conduit 53 but that the column of liquid remains below the reservoir 59. In the unplanned for event that the pressure increases and the column of liquid reaches the reservoir 59, the liquid will be drained through the overflow conduit 61 and back into the upper tub 44 to prevent overflow of the liquid.

The dishwasher described above having a single pump and filtration system and a single water supply system for a multi-compartment dishwasher offers many benefits. For example, current multi-compartment dishwashers use identical separate wash systems and water supply systems for each separate chamber. Such separate wash systems and water supply systems require multiple water inlet valves, pumps, motors, electrical connections, etc., which increases the cost of producing such machines. The dishwasher described above eliminates the need for multiple wash systems and water supply systems and may thereby reduce the cost to produce such a dishwasher.

Further, having a common pump and filter unit and a single water supply system may also increase the space available within the chassis and this correlates to the ability to install larger wash tubs in the chassis. Larger wash tubs may result in a larger capacity for utensils, which allows for more utensils to be treated at one time. This results in a saving of both time and energy as the dishwasher needs to be run fewer times to treat the same amount of utensils. Further, the availability of more space allows a user to place larger utensils into the wash compartments with more flexibility with respect to loading patterns of the utensils.

While the invention has been specifically described in connection with certain specific embodiments thereof, it is to be understood that this is by way of illustration and not of limitation. For example, although the above description relates to a multi-compartment dishwasher having two separate compartments it has been contemplated that the invention may work with multi-compartment dishwashers having three or more compartments. Reasonable variation and modification are possible within the scope of the forgoing disclosure and drawings without departing from the spirit of the invention which is defined in the appended claims.

What is claimed is:

1. A dishwasher comprising:
a first tub at least partially defining a first treating chamber;
a first sprayer fluidly coupled to the first treating chamber and supplying a first spray of liquid to the first treating chamber;
a second tub at least partially defining a second treating chamber;
a second sprayer fluidly coupled to the second treating chamber and supplying a second spray of liquid to the second treating chamber;
a remote sump and filter unit located exteriorly of the first and second tubs and comprising:
a housing defining a sump having an inlet fluidly coupled to the first and second tubs to collect liquid from the first and second tubs and having an outlet fluidly coupled to the first and second sprayers to define first and second recirculation flow paths from the sump to the first and second sprayers, respectively; and
a filter located within the sump and fluidly separating the housing inlet from the housing outlet to filter liquid recirculated through the sump; and
a water supply system comprising a supply conduit extending from a liquid source to the housing to direct liquid from the liquid source to the sump;
wherein the water supply system provides liquid to the sump, which then supplies the liquid to both the first and second treating chambers, thereby eliminating the need for separate water supplies for the first and second treating chambers.

2. The dishwasher of claim 1 wherein the water supply system further comprises a siphon break provided in the supply conduit.

3. The dishwasher of claim 2 wherein the siphon break comprises an open-top cup, separating the supply conduit into a first portion supplying liquid to the cup and a second portion fluidly coupling the cup to the housing.

4. The dishwasher of claim 3 wherein the siphon break further comprises an overflow conduit fluidly coupled to at least one of the first and second tubs.

5. The dishwasher of claim 4 wherein the filter is a rotatable filter and upon rotation generates sufficient pressure in the housing to effect the formation of a column of supply water in the supply conduit.

6. The dishwasher of claim 5 wherein at least one of a rotational speed of the filter, a configuration of the supply conduit, and a location of the siphon break are selected such that the column of water remains below the siphon break.

7. The dishwasher of claim 1 wherein the filter is a rotatable filter.

8. The dishwasher of claim 7 wherein the filter is rotatable such that upon rotation it generates sufficient pressure in the housing to effect the formation of a column of supply water in the supply conduit.

9. The dishwasher of claim 1, further comprising a wash pump selectively fluidly coupled to the first and second recirculation paths to selectively pump the liquid from the sump to the first and second sprayers.

10. The dishwasher of claim 9, further comprising a drain pump having an inlet fluidly coupled to the sump and an outlet configured to fluidly couple to a household drain.

11. The dishwasher of claim 10 wherein the wash pump and drain pump are mounted to the housing.

12. The dishwasher of claim 11 wherein the wash pump has an impeller rotatable about a first axis of rotation, the drain pump has an impeller rotatable about a second axis of rotation, and the housing has a longitudinal axis, and the wash pump, drain pump, and housing are arranged such that the first and second axes of rotation are generally parallel with the longitudinal axis to form an overall elongated configuration.

13. The dishwasher of claim 12 wherein the filter is a rotating filter having a third rotational axis, which is parallel to the first and second axes of rotation and the longitudinal axis.

14. The dishwasher of claim 13 wherein the first, second, and third axes of rotation are collinear.

15. The dishwasher of claim 14 wherein the longitudinal axis is collinear with the first, second, and third axes of rotation to define a longitudinal axis for the remote sump and filter unit.

16. The dishwasher of claim 1, further comprising a cabinet defining an interior in which the first and second tubs are located.

17. The dishwasher of claim 16 wherein the remote sump and filter unit is located in a lower-rear portion of the interior such that the longitudinal axis of the remote sump and filter unit is generally parallel to a rear wall of the cabinet.

18. The dishwasher of claim 17 wherein the filter is mounted to the impeller of the wash pump to effect the rotation of the filter.

19. The dishwasher of claim 18 wherein the housing further comprises opposing ends and the wash pump is mounted to one of the opposing ends and the drain pump is mounted to the other of the opposing ends.

20. The dishwasher of claim 16, further comprising a moveable element for providing access to the first and second tubs.

21. The dishwasher of claim 20 wherein the moveable element is one of a door and drawer.

22. The dishwasher of claim 21 wherein the moveable element comprises a first drawer defining the first tub, and a second drawer defining the second tub, and the remote sump and filter unit is not carried by either the first and second drawers.

23. The dishwasher of claim 1 wherein the housing inlet is selectively fluidly coupled to the first and second tubs and the housing outlet is selectively fluidly coupled to the first and second sprayers.

24. A dishwasher comprising:
a cabinet defining an interior;
a tub located within the interior and at least partially defining a treating chamber;
a sprayer fluidly coupled to the treating chamber and supplying a spray of liquid to the treating chamber;
a remote sump unit located within the interior and exteriorly of the tub, and comprising a housing defining a sump having an inlet fluidly coupled to the tub to collect the sprayed liquid from the tub and having an outlet fluidly coupled to the sprayer to define a recirculation flow path from the sump to the sprayer; and
a water supply system comprising a supply conduit extending from a liquid source to the housing to direct liquid from the liquid source to the sump;
wherein the water supply system provides liquid to the sump, which is then supplied to the treating chamber.

25. The dishwasher of claim 24 wherein the water supply system further comprises a siphon break provided in the supply conduit.

26. The dishwasher of claim 25 wherein the siphon break comprises an open top cup separating the supply conduit into a first portion supplying liquid to the cup and a second portion fluidly coupling the cup to the housing.

27. The dishwasher of claim 26 wherein the siphon break further comprises an overflow conduit fluidly coupled to the tub.

28. The dishwasher of claim 25, further comprising a rotating filter located within the sump and fluidly separating the housing inlet from the housing outlet to filter liquid recirculated through the sump and wherein the filter is rotatable such that upon rotation it generates sufficient pressure in the housing to effect the formation of a column of supply water in the supply conduit.

29. The dishwasher of claim 28 wherein at least one of a rotational speed of the filter, a configuration of the supply conduit, and a location of the siphon break are selected such that the column of water remains below the siphon break.

30. The dishwasher of claim 24, further comprising a wash pump fluidly coupled to the recirculation flow path to pump the liquid from the sump to the sprayer.

31. The dishwasher of claim 30, further comprising a drain pump having an inlet fluidly coupled to the sump and an outlet configured to fluidly couple to a household drain.

32. The dishwasher of claim 31 wherein the wash pump and drain pump are mounted to the housing.

33. The dishwasher of claim 24, further comprising a rotating filter located within the sump and fluidly separating the housing inlet from the housing outlet to filter liquid recirculated through the sump.

34. The dishwasher of claim 33 wherein the filter is rotatable such that upon rotation it generates sufficient pressure in the housing to effect the formation of a column of supply water in the supply conduit.

35. The dishwasher of claim 33 wherein the wash pump has an impeller rotatable about a first axis of rotation, the drain pump has an impeller rotatable about a second axis of rotation, and the housing has a longitudinal axis, and the wash pump, drain pump, and housing are arranged such that the first and second axes of rotation are generally parallel with the longitudinal axis to form an overall elongated configuration.

36. The dishwasher of claim 35 wherein the filter is a rotating filter having a third rotational axis, which is parallel to the first and second axes of rotation and the longitudinal axis.

37. The dishwasher of claim 36 wherein the first, second, and third axes of rotation are collinear.

38. The dishwasher of claim 37 wherein the longitudinal axis is collinear with the first, second, and third axes of rotation to define a longitudinal axis for the remote sump and filter unit.

39. The dishwasher of claim 38 wherein the remote sump and filter unit is located in a lower-rear portion of the interior such that the longitudinal axis of the remote sump and filter unit is generally parallel to a rear wall of the cabinet.

40. The dishwasher of claim 39 wherein the filter is mounted to the impeller of the wash pump to effect the rotation of the filter.

41. The dishwasher of claim 40 wherein the housing further comprises opposing ends and the wash pump is mounted to one of the opposing ends and the drain pump is mounted to the other of the opposing ends.

42. The dishwasher of claim 24 wherein the cabinet further comprises a moveable element for providing access to tub.

43. The dishwasher of claim 42 wherein the moveable element is one of a door and drawer.

44. The dishwasher of claim 43 wherein the moveable element comprises a drawer defining the tub, and the filter unit is not carried by the drawer.
